(19) United States
(12) Patent Application Publication
(10) Pub. No.: US 2003/0020052 A1
(43) Pub. Date: Jan. 30, 2003

(54) Piezoelectric single crystal element

(76) Inventors: Herbert Thanner, Graz (AT); Peter W. Krempl, Kainbach (AT)

Correspondence Address: Dykema Gossett PLLC, Suite 300 West, 1300 I Street, N.W., Washington, DC, 20005-3306, US

(21) Appl. No.: 10/086,537

(22) Filed: Mar. 4, 2002

(30) Foreign Application Priority Data
Jul. 26, 2001 (AT) A 1171/2001

(51) Int. Cl. H01B 1/00

(52) U.S. Cl. 252/500

(57) ABSTRACT

The invention relates to a piezoelectric single crystal element which is provided with electrodes on at least one face or on opposing faces and is excitable to produce a thickness shear vibration. In accordance with the invention the single crystal element has a crystal cut with a fundamental resonance frequency excitable in the thickness shear mode, in which the effective electromechanical coupling factor k_{eff} is between 0.05% and 3%, and preferably, between 0.1% and 2%. This allows resonators with a high quality factor to be produced.

### BACKGROUND OF THE INVENTION

The invention relates to a piezoelectric single crystal element which is provided with electrodes on at least one face or on opposing faces and may be excited to produce a thickness shear vibration, and to different applications and a method for manufacturing such a piezoelectric single crystal element or resonator element.

The resonance frequency of a piezoelectric resonator depends on the effective material constants and physical dimensions, and on the interaction with its environment (e.g., pressure, temperature, mass load). As a consequence, two basically different fields of application will result. Firstly, piezoelectric resonators are used as frequency standards, the resonator typically being provided in the feedback loop of an oscillator, which will stabilize oscillator frequency in the vicinity of resonance frequency. In this instance, influences of the environment on resonance frequency are kept largely constant by using hermetically sealed housings that are either filled with a protective gas or evacuated. Secondly, piezoelectric resonators are used as sensor elements, any measured changes in resonance properties serving as indicators for the physical or chemical properties of the environment and their change over time. In both fields of application the quality factor of the respective resonance frequency should be as high as possible, in order to obtain a high short-term stability in addition to maximum values for measuring resolution and measuring sensitivity.

Definition of Quality Factor Q:

$${Q = \frac{{f}_{m}}{2} \frac{ⅆ ϕ}{ⅆ f} \vert}_{f = f m} \qquad Equation 1$$

with

φ . . . phase

f . . . frequency

fₘ . . . frequency at maximum admittance φ measured in radians and f, fₘ in Hz.

The quality factor may be determined by measuring the change in phase Δφ taking place in a frequency interval Δf in the immediate vicinity of maximum admittance, for instance by means of a network analyzer. This method was used for determining the quality factors presented in FIG. 2.

The effective electromechanical coupling factor k_{eff} for fundamental resonance frequency or series resonance frequency fₛ is defined by:

$${k}_{eff} = \sqrt{\frac{{e}_{eff}^{2}}{{c}_{eff}^{D} {ϵ}_{eff}^{S}}} \qquad Equation 2$$

with

e_{eff} . . . effective piezoelectric modulus

c_{eff}^{D} . . . effective elastic shear constant (D=constant)

ε_{eef}^{S} . . . effective dielectric constant (S=constant)

D, S . . . dielectric displacement, strain tensor

The effective material constants eff

$${e}_{eff} , {c}_{eff}^{D}$$

and

$${ϵ}_{eff}^{S}$$

will depend on the cutting angle and may be calculated from the material constants of the respective crystal material (for example, see S. Haussühl, Kristallphysik, Physik Verlag, ISBN 3-87664-587-5).

The effective electromechanical coupling factor k_{eff} may be determined by network analysis, for instance. For this purpose the resonance behavior of the piezoelectric resonator is modelled on a series resonance circuit with a parallel capacitance. The distance between series resonance frequency fₛ≅fₘ (for a definition refer to FIG. 1) and parallel resonance frequency fₚ≅fₙ (fₙ . . . frequency at minimum admittance, see FIG. 1) will yield the effective electromechanical coupling factor k_{eff} as:

$${k}_{eff} = \sqrt{\frac{{f}_{p}^{2} - {f}_{s}^{2}}{{f}_{p}^{2}}} \qquad Equation 3$$

All given values for the effective electromechanical coupling factor k_{eff} refer to the fundamental resonance frequency fₛ of the respective piezoelectric crystal cut or piezoelectric resonator.

### DESCRIPTION OF PRIOR ART

From Warner A. W., “Design and Performance of Ultraprecise 2.5-mc Quartz Crystal Units”, Bell Sys. Techn. J., September, 1960, pp. 1193-1215, for example, it is known that a quartz AT-cut resonator (effective electromechanical coupling factor k_{eff}=8% . . . 9%) with a diameter of 30 mm, plane-convex faces, gold electrodes, at room temperature and under vacuum (p=1.33*10⁻⁹ bar) will reach a quality factor Q of 5 to 6 millions in the fifth harmonic at a resonance frequency of 2.5 MHz. In the same context an inverse relationship has been found between resonance frequency fₛ (definition cf. FIG. 1) and maximum possible quality Q. For a quartz AT-cut resonator this empirically found relationship may be represented by the product of Q*fₛ=16*10⁶ MHz.

In Ch. Longet, G. Robichon, EFTF, 1995, pp. 141-145, an assembly with non-adhering electrodes is described, by means of which, on the basis of a quartz BT cut resonator, a product of Q*fₛ=30*10⁶ MHz is obtained. The excitation electrodes are not provided on the resonator faces themselves, but at a distance of some μm (so-called PVA resonators). Such quartz resonators, which are described in U.S. Pat. No. 4,135,108 A, for example, are comparatively large and difficult to produce.

From R. C. Smythe, R. C. Helmbold, G. E. Hague, & K. A. Snow, Joint Meeting EFTF—IEEE IFCS, 1999, pp. 816-820, it is known that a Y-cut langanite (LGT) resonator (effective electro-mechanical coupling factor k_{eff}>10%) with a diameter of 14 mm, plane-convex faces, gold electrodes, at room temperature and under vacuum (p=1.33*10⁻⁷ bar), in the 7^{th} harmonic at a resonance frequency of 14.058 MHz, will reach a quality factor Q of 1.8 millions. This corresponds to a product Q*fₛ=25.6*10⁶ MHz.

### SUMMARY OF THE INVENTION

It is the object of the present invention to propose a piezoelectric single crystal and a process for its manufacture, where particularly high values may be obtained for the quality factor Q, especially at vacuum pressures of less than 10 mbar.

According to the invention this object is achieved by providing that the single crystal element have a crystal cut with a fundamental resonance frequency excitable in the thickness shear mode, in which the effective electromechanical coupling factor k_{eff} is between 0.05% and 3%, and more preferably, between 0.1% and 2%.

It is preferable to use crystal materials with an effective elastic shear constant of C_{eff}^{D} in the range of 10 to 100 GNm⁻². It is further preferable to select crystal materials where the chosen crystal cut is not prone to hysteresis between the electric field E generated by the excitation electrodes and the field of dielectric displacement D.

It has been found unexpectedly, for example, that a piezoelectric resonator based on gallium orthophosphate (GaPO₄), with a diameter of 7.4 mm and gold electrodes, which has a comparatively low effective electromechanical coupling factor k_{eff} of about 0.2% to 0.4%, will have a very high quality factor at an absolute pressure of 5*10⁻⁵ bar. Compared with a quartz resonator the GaPO₄ resonator is much more compact (diameter of 7.4 mm) and, at a thickness of 0.2 mm (at a resonance frequency of about 10 MHz), has a better diameter/thickness ratio.

If the crystal element is subject to thermal treatment of more than 150° C. after application of the electrodes, quality values of more than 8.7 millions may be obtained for a resonance frequency fₛ of approximately 9.816 MHz in the fundamental mode. This will yield a product of Q*fₛ=85*10⁶ MHz. The crystal element could also be heated to more than 150° C. during application of the electrodes. The electrodes may be applied by chemical vapour deposition, or physical vapour deposition, preferably by sputtering.

It is of special advantage if the piezoelectric resonator is heated to temperatures of more than 150° C. for several hours once the electrodes have been applied. For example, a GaPO₄ resonator (fₛ=5.903 MHz) tempered at approx. 350° C. for about 10 hours shows an increase of the quality factor from about 350,000 at normal pressure to about 13 millions at an absolute pressure of p=40μbar. A non-tempered GaPO₄ resonator (f=5.872 MHz) on the other hand, with a quality factor of about 350,000 at normal pressure, has a quality factor of approx. 1.75 millions at an absolute pressure of 30 μbar.

The method according to the invention is thus characterized by the following steps:

Producing a crystal cut with an excitable fundamental resonance frequency, the effective electromechanical coupling factor k_{eff} lying between 0.05% and 3%, and preferably between 0.1% and 2%; and

Applying electrodes for excitation on at least one face or on opposing faces of the single crystal element; and, if desirable,

Tempering the crystal cut at temperatures higher than 150° C.

It is a further characteristic of the invention that the frequency spacing to the nearest excitable anharmonic resonance frequency amounts to >80 kHz, and preferably >100 kHz. Maximum admittance of the harmonics should be <10%, and preferably <5% relative to the fundamental resonance frequency, i.e., the nth harmonic (n=3,5 . . . ) should no longer be significantly excitable.

With crystals of point group 32, for example, the thermal expansion behavior in the plane of the crystal cut can be fully described by two expansion coefficients α₁₁=α₂₂ and α₃₃, which are linearly independent of each other. It has proved of special advantage if a crystal cut is chosen for which the effective thermal expansion coefficients (α′₁₁ and α′₃₃) in the plane of the crystal cut will deviate from each other by a mere factor <1.5.

It is further proposed by the invention that a crystal cut be chosen for which the temperature dependence of the resonance frequency of the thickness shear vibration to be excited should be as small as possible in the temperature range used. This will be the case if the linear temperature coefficient of the fundamental resonance frequency amounts to zero at least at one point in the region of the operating temperature of the piezoelectric single crystal element, preferably in the range of 10° C. to 100° C. (i.e., a temperature-compensated cut). For this purpose the temperature dependence of the resonance frequency must be parabolic or cubic over frequency, resulting in a linear zero temperature coefficient within the temperature range used.

According to a first variant of the invention the crystal material belongs to crystallographic point group 32, the crystal element preferably consisting of quartz-homeotypical gallium orthophosphate (GaPO₄).

A combination of particularly positive properties, such as extremely high quality values, temperature compensation of resonance frequency and wide spacing between fundamental resonance frequency and its anharmonic modes, may be obtained by employing a piezoelectric resonator based on GaPO₄, i.e., by using a singly rotated Y-cut, the rotation angle φ being between −80° and −88°, and especially between −82° and −86°.

The signs for the rotation angles φ indicating the sense of rotation about the crystallographic axes are based on the “IEEE Standard on Piezoelectricity; ANSI/IEEE Std. 176-1987.

In a variant of the invention the proposal is put forward that piezoelectric crystal elements be used which belong to the crystallographic space group P321 mentioned in “INTERNATIONAL TABLES FOR X-RAY CRYSTALLOGRAPHY, The Kynoch Press, 1969, pp. 255, for example. Crystals of this space group have a Ca₃Ga₂Ge₄O₁₄-analogous crystal structure, such as single crystals of langasite (La₃Ga₅SiO₁₄), langanite (La₃Ga_{5,5}Nb_{0,5}O₁₄), langatate (La₃Ga_{5,5}Ta_{0,5}O₁₄) or strontium-gallium-germanate (Sr₃Ga₂Ge₄O₁₄). Further examples are cited in B. V. Mill, Yu. V. Pisarevsky, E. L. Belokoneva, “Synthesis, Growth and some Properties of Single Crystals with the Ca₃Ga₂Ge₄O₁₄ Structure”, Joint Meeting EFTF—IEEE IFCS, 1999, pp. 829-834.

With single crystals of langasite (La₃Ga₅SiO₁₄) especially, the choice of a singly rotated Y-cut with a rotation angle φ between −55° and −85°, and preferably between −60° and −70°, will help obtain a combination of low coupling and temperature compensation.

Electric vacuum gauges will give indirect pressure measurements via particle density, which at a given pressure depends on the given type of gas. The pressure scales of such instruments usually refer to nitrogen pressures. If the pressure of some other gas (mixture) is to be determined the indicated pressure must be multiplied by a certain factor. If heat conduction vacuum gauges (Pirani) are used these factors are pressure-dependent as well.

Due to the high pressure sensitivity of the quality factor, especially at vacuum pressures of less than 10 mbar, the crystal elements proposed by the invention are particularly well suited for measuring pressure, such pressure measurements being independent of the type or composition of the given gas.

On account of the potential combination of temperature compensation of resonance frequency and low electromechanical coupling, for instance with GaPO₄ and langasite, the crystal element according to the invention may be employed as a frequency-determining element (frequency standard) in oven-controlled or thermostatted oscillators.

According to another advantageous proposal the crystal element of the invention may be employed in a vacuum (p<10 mbar) as a microbalance sensor element, where an extremely high sensitivity to massloads may be obtained.

Finally the crystal element of the invention may be used as an electronic filter with a particularly high slope steepness.

### BRIEF DESCRIPTION OF THE DRAWINGS

The invention will now be explained in more detail, with reference to the enclosed drawings, in which:

FIG. 1 shows a diagram of admittance, wherein conductance is plotted on the abscissa and susceptance on the ordinate, and

FIG. 2 a diagram of quality factor Q as a function of pressure for GaPO₄, and

FIG. 3 the first temperature coefficient of the resonance frequency of a GaPO₄ thickness shear resonator as a function of rotation angle φ.

### DETAILED DESCRIPTION OF THE PREFERRED EMBODIMENTS

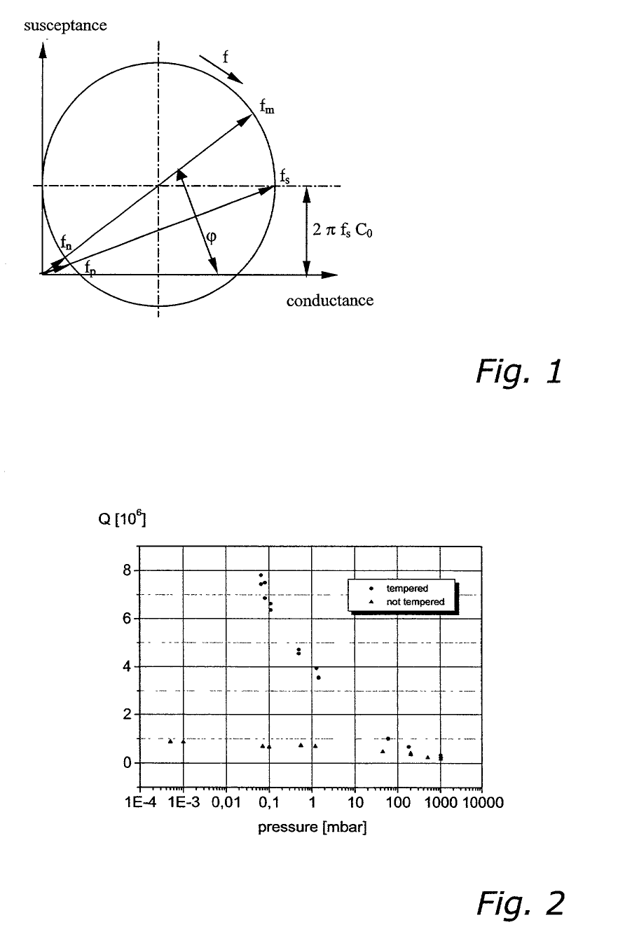

FIG. 1 shows the Nyquist plot of the admittance, which is used for describing the electric behavior of a piezoelectric resonator. In the same way the relevant definitions of series resonance frequency fₛ, frequency at maximum admittance fₘ, parallel resonance frequency fₚ, and frequency at minimum admittance fₙ are given. The distance between the center of the circle and the abscissa is proportional to the parallel capacitance C₀, which is formed by the resonator together with the applied electrodes for excitation.

FIG. 2 shows the increase in the quality factor of a GaPO4 resonator (singly rotated Y-cut mit k_{eff} between 0.2% and 0.4%), which was tempered after application of the electrodes, compared to a non-tempered resonator (fundamental resonance frequency approx. 6 MHz). At normal pressure, quality values are at the same level in both cases. When the pressure is reduced the quality values of the tempered resonator increase significantly over those of the untempered resonator.

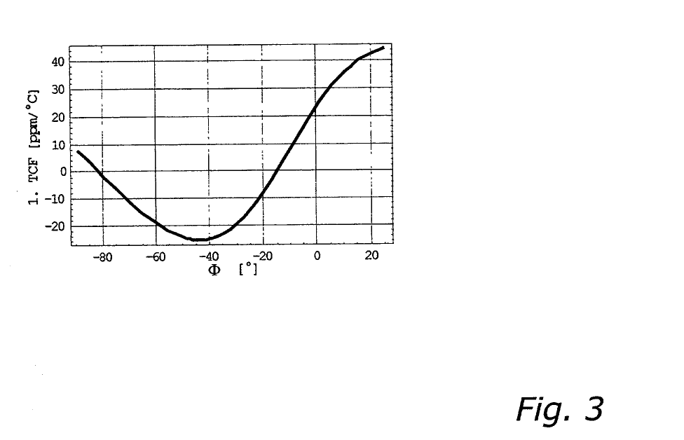

FIG. 3 shows the linear temperature coefficient (1^{st} TCF) of the resonance frequency of a singly rotated Y-cut of a GaPO₄ thickness shear resonator (C-mode) as a function of the rotation angle φ, at a temperature of approx. 85° C.

What is claimed is:

1. Piezoelectric single crystal element which is provided with electrodes for excitation on at least one face or on opposing faces and is excitable to produce a thickness shear vibration, wherein said single crystal element has a crystal cut with a fundamental resonance frequency excitable in a thickness shear mode, in which the effective electromechanical coupling factor k_{eff} is between 0.05% and 3%.

2. Piezoelectric single crystal element according to claim 1, wherein said electromechanical coupling factor k_{eff} is between 0.1% and 2%.

3. Piezoelectric single crystal element according to claim 1, wherein the frequency spacing to the nearest excitable anharmonic resonance frequency amounts to >80 kHz.

4. Piezoelectric single crystal element according to claim 3, wherein the frequency spacing to the nearest excitable anharmonic resonance frequency amounts to >100 kHz.

5. Piezoelectric single crystal element according to claim 1, wherein maximum admittance of the harmonics is <10% relative to said fundamental resonance frequency.

6. Piezoelectric single crystal element according to claim 5, wherein maximum admittance of the harmonics is <5% relative to said fundamental resonance frequency.

7. Piezoelectric single crystal element according to claim 1, wherein said single crystal element is tempered at temperatures of more than 150° C.

8. Piezoelectric single crystal element according to claim 1, wherein the effective thermal expansion coefficients in the plane of said crystal cut deviate from each other by a factor <1.5.

9. Piezoelectric single crystal element according to claim 1, wherein the linear temperature coefficient of said fundamental resonance frequency amounts to zero at least at one point in the region of a operating temperature of said piezoelectric single crystal element.

10. Piezoelectric single crystal element according to claim 9, wherein said operating temperature is in the range of 10° C. to 100° C.

11. Piezoelectric single crystal element according to claim 1, wherein said single crystal element consists of a crystal belonging to crystallographic point group 32.

12. Piezoelectric single crystal element according to claim 11, wherein said crystal element consists of quartz-homeotypic gallium orthophosphate (GaPO₄).

13. Piezoelectric single crystal element according to claim 12, wherein the crystal element is a singly rotated Y-cut with a rotation angle φ between −80° and −88°.

14. Piezoelectric single crystal element according to claim 13, wherein said rotation angle φ is between −82° and −86°.

15. Piezoelectric single crystal element according to claim 11, wherein said crystal element consists of at least one crystal material selected from a group consisting of langasite (La₃Ga₅SiO₁₄), langanite (La₃Ga_{5,5}Nb_{0,5}O₁₄), and langatate (La₃Ga_{5,5}Ta_{0,5}O₁₄).

16. Piezoelectric single crystal element according to claim 15, wherein the crystal element is a singly rotated Y-cut of langasite (La₃Ga₅SiO₁₄), with a rotation angle φ between −55° and −85°.

17. Piezoelectric single crystal element according to claim 16, wherein said rotation angle φ is between −60° and −70°.

18. Piezoelectric single crystal element according to claim 1, wherein said single crystal element consists of a crystal belonging to crystallographic space group P321.

19. Piezoelectric single crystal element according to claim 18, wherein said crystal element consists of strontium-gallium-germanate (Sr₃Ga₂Ge₄O₁₄).

20. Method for manufacture of a piezoelectric single crystal element which is excitable in a thickness shear mode, comprising the steps of producing a crystal cut with an excitable fundamental resonance frequency, having an effective electromechanical coupling factor k_{eff} lying between 0.05% and 3%, and applying electrodes for excitation on at least one face or on opposing faces of said single crystal element.

21. Method according to claim 20, wherein said electromechanical coupling factor k_{eff} laying between 0.1% and 2%.

22. Method according to claim 20, wherein said crystal element is heated to temperatures of more than 150° C. during application of said electrodes.

23. Method according to claim 20, wherein said crystal element is subject to a thermal treatment of more than 150° C. after application of said electrodes.

24. Use of a piezoelectric crystal element according to claim 1, as a pressure gauge at vacuum pressures of less than 10 mbar.

25. Use of a piezoelectric crystal element according to claim 1, as a frequency-determining element in oven-controlled or thermostatted oscillators.

26. Use of a piezoelectric crystal element according to claim 1, as a microbalance sensor element, at vacuum pressures <10 mbar.

27. Use of a piezoelectric crystal element according to claim 1, as an electronic filter with high slope steepness.

28. Use of a piezoelectric crystal element according to claim 20, as a pressure gauge at vacuum pressures of less than 10 mbar.

29. Use of a piezoelectric crystal element according to claim 20, as a frequency-determining element in oven-controlled or thermostatted oscillators.

30. Use of a piezoelectric crystal element according to claim 20, as a microbalance sensor element, at vacuum pressures <10 mbar.

31. Use of a piezoelectric crystal element according to claim 20, as an electronic filter with high slope steepness.
